(19) United States
(12) Patent Application Publication
(10) Pub. No.: US 2002/0194187 A1
(43) Pub. Date: Dec. 19, 2002

(54) Multi-paradigm knowledge-bases

(76) Inventors: John McNeil, La Jolla, CA (US); Alan Goates, Cardiff, CA (US); Ronald P. Blanford, Poway, CA (US); Karen A. Do, San Diego, CA (US); Daniel A. Sherman, San Diego, CA (US); Robin Warren, Temecula, CA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/150,668

(22) Filed: May 16, 2002

Related U.S. Application Data
(60) Provisional application No. 60/291,459, filed on May 16, 2001.

(51) Int. Cl. G06F 7/00

(52) U.S. Cl. 707/100

(57) ABSTRACT

Knowledge-bases are disclosed. In accordance with preferred embodiments, such knowledge-bases comprise pluralities of knowledge-elements as well as pluralities of knowledge-relationships dynamically forming the relationships among the knowledge-elements. Such knowledge-base may be assessed to determine knowledge syntheses of utility per se or to capture further knowledge-elements for augmentation of the knowledge-base. In accordance with a preferred embodiment, the knowledge-base is used to exert operative control over one or more manipulable device.

### CROSS REFERENCE TO RELATED APPLICATIONS

This application claims the benefit of U.S. Provisional Application Serial No. 60/291,459 filed May 16, 2001, the contents of which are incorporated herein by reference in its entirety.

### FIELD OF THE INVENTION

The present invention relates generally to the field of informatics and more particularly to knowledge-bases, organizational paradigms for knowledge-bases and examiners/viewers of knowledge-bases and related structures for storing, organizing and interpreting knowledge-elements and forms of information to facilitate scientific, commercial, educational and a wide variety of other activities. The present invention is also directed to methods and systems for using, viewing, interpreting, and appreciating such knowledge-bases and to development of insights derived therefrom.

### BACKGROUND OF THE INVENTION

There is a growing need in many fields of endeavor, especially in the scientific community, to improve the utilization of information and bits of knowledge gathered from many different sources. These can include, for example, company and academic reports, papers, databases and the like as well as information from many diverse sources including the Internet. Raw information, data, hypotheses, conclusions, and observations are not particularly useful unless and until the same are carefully organized in a way that makes them understandable, interpretable and accessible. Organization and viewing alternatives are what is required to convert individual knowledge-elements into useful knowledge, which provides unforeseen relationships.

Informatics is the study and application of computer and statistical techniques to the management of information. In genome projects, bioinformatics includes the development of methods to search databases quickly, to analyze nucleic acid sequence information, and to predict protein sequence and structure from DNA sequence data. Increasingly, molecular biology is shifting from the laboratory bench to the computer desktop. Advanced quantitative analyses, database comparisons, and computational algorithms are needed to explore the relationships between sequence and phenotype.

One use of bioinformatics involves studying genes differentially or commonly expressed in different tissues or cell lines such as in normal or cancerous tissue. Such expression information is of significant interest in pharmaceutical research. A sequence tag method is used to identify and study such gene expression. Complementary DNA (cDNA) libraries from different tissue or cell samples are available. cDNA clones, or expressed sequence tags (ESTs) that cover different parts of the mRNA(s) of a gene are derived from the CDNA libraries. The sequence tag method generates large numbers, such as thousands, of clones from the cDNA libraries. Each cDNA clone can include about 100 to 800 nucleotides, depending on the cloning and sequencing method. Assuming that the number of sequences generated is directly proportional to the number of mRNA transcripts in the tissue or cell type used to make the cDNA library, then variations in the relative frequency of occurrence of those sequences can be stored in computer databases and used to detect the differential expression of the corresponding genes.

Sequences are compared with other sequences using heuristic search algorithms such as the Basic Alignment Search Tool (BLAST). BLAST compares a sequence of nucleotides with all sequences in a given database. BLAST looks for similarity matches, or ‘hits’, that indicate the potential identity and function of the gene. BLAST is employed by programs that assign a statistical significance to the matches using the methods of Karlin and Altschul (Karlin S., and Altschul, S. F. (1990) Proc. Natl. Acad. Sci. U.S.A. 87(6): 2264-2268; Karlin, S. and Altschul, S. F. (1993) Proc. Natl. Acad. Sci. U.S.A. 90(12): 5873-5877). Homologies between sequences are electronically recorded and annotated with information available from public sequence databases such as GenBank. Homology information derived from these and other comparisons provides a basis for assigning function to a sequence.

Conventional relational databases store relationships between database items implicitly. The defining term “relational” characterizes that each member of the database is predetermined to relate to at least one other member of the database. The connections between items stored in these tables are made programmatically; they are not extrinsically determined and subsequently stored. The relational database model works well for accounting data and other types of data that rely on human constructed paradigms, which require a flat logic rule-set. One example of this type of database may be found in U.S. Pat. No. 6,389,428 to Rigault et al. which issued May 14, 2002 and is directed to a precompiled database for biomolecular sequence information. This patent attempts to provide flexibility to the database paradigm through the use of stored entities and attributes for each biomolecular entry. Although this approach may provide moderate increases in search speed, it does not solve the underlying problem, biological data doesn't fall into rigid “Rows & columns” style thinking quite so easily, and often demands a more flexible rule-set. The individual data items stored within a relational database relate one to another, by definition. The basic framework of a relational database demands that many, if not all, relationships be foreseen and defined within the data structure and/or at least in the computer code that defines the database. One example of this is seen in U.S. Pat. No. 6,303,297 to Lincoln, et al. issued Oct. 16, 2001, which is directed to a computerized storage and retrieval system for genetic information and related annotated information. The data of the system is stored in a relational database which interfaces with public databases to allow analysis both within the database and between information within that database and external public databases. The sequence data is edited before entry into the system, and is stored in a curated, functional clustering organization. The information associated with the data is stored in an expression database that is linked to the storage of the sequence data. This database does not solve the problems of flexibility and innate variability of biological data, but seeks to force that data into a man-contrived relational system. Regardless of the level of curation, this database is unable to present anything other than the relationships foreseen by the developers.

In typical relational databases, relationships are defined as a one-to-many or a many-to-many relationship in the program code itself, as taught in U.S. Pat. No. 6,223,186 to Rigault et al, issued Apr. 24, 2001. This patent is directed to a computer system that stores biomolecular data in a database in a memory. The biomolecular database has a set of entities. Each entity stores attributes for a plurality of entries. At least one attribute is stored in an array. Data associated with an entry is stored at a location in the array. An entity offset designates the location of the data in the array. The same entity offset value is used to access data associated with a particular entry for all attributes of that entity. Moreover, in this patent and similar databases each data point must have at least one strict, or set, relationship, meaning that understanding of the data including their interrelationships cannot change over time, i.e. must be static, as depicted in U.S. Pat. No. 6,023,659 to Seilhamer et al, issued on Feb. 8, 2000. This patent is directed to a relational database system for storing biomolecular sequence information in a manner that allows sequences to be catalogued and searched according to one or more protein function hierarchies. The hierarchies allow searches for sequences based upon a protein's biological function or molecular function, but nothing else. Also disclosed is a mechanism for automatically grouping new sequences into these same rigid protein function hierarchies.

The practice of the databases of the prior art required an understanding of which data related to which other data, before the database was compiled. Indeed, none of these databases accounted for variability in data relationships, or which data entries may be subject to change according to advancing scientific understanding. However, even where the variable nature of a data point was understood, there was no manageable way to incorporate that data variabileness into a relational database, as now understood in the art because of the rule-set thereon imposed. A database that stores variable data is at risk of requiring frequent revisions to accommodate the changes. Since the underlying understanding of biological systems often changes, this further increases the difficulty of designing a database able to properly contain and query biological data.

One attempt to overcome this limitation is to include descriptive information into each data entry with the accompanying analysis software to define each relationship. This paradigm generates a descriptive type relationship of each data. Relationships are then pre-formed among data elements having similar descriptions. However, the descriptions for each element or entry must be designated in the database prior to performing a query on that data. Importantly, there is no difference between an ownership type of relationship and a descriptive type of relationship, because in both cases the software layer on top of the database requires that relationship be defined and known, at least to the software. Imposing them in software again leads to endless software revisions. Furthermore, because the relationships are all known and defined as part of the data entry itself, the database is simply a storehouse of facts, which are related to other facts according to a known relationship incapable of determining a new relationship or function. For at least this reason relational databases have not been a useful tool for research, aimed at the discovery of unknown relationships in biological data.

Additionally, traditional relational databases require the individual nature of a data value. Although relational databases according to this paradigm may house data on, for example, numerous shades of red, these shades must retain their individual nature, and may never, simultaneously also be a shade of another color, such as purple, for example. The failings of this required uniqueness are most acutely felt where the database stores biological data which by its very nature is variable and multi-classed.

Describing, storing and retrieving biological data is an inherently complex process. A database used to analyze biological systems must manage this complexity and must take into account that the collection of the basic biological data is in itself variable, depending on experimental methods. A framework specifically designed to collect and analyze complex biological data sets, glean information about the source and experimental conditions.

Moreover, analysis of the massive amounts of data regarding detection methods, countermeasures and bio-threat responses that are required for effective bio-warfare defense will only be possible using rapid modeling and simulation of biological systems, which are validated with vast amounts of experimental data. The basic scientific loop of hypothesize, experiment and interpret, as applied to these time critical analysis requires acceleration of the process beyond the rate humans can track manually. One solution to this problem would engages a software frame work that does more than examine loosely connected repositories of observations. The frame work must manage hypotheses, experimental process information and results, and automated interpretation based on system modeling. Further, the system must facilitate the answering of complex questions, using all information simultaneously. The answers to such questions, including the very questions asked would together form the basis for additional insights and hypotheses, to evaluate the truthfulness of hypotheses and models.

One factor that stands in the way of the creation of such a framework is the lack of standardized methods for communicating and querying the diverse universe of biological information data. There are a multitude of repositories of data sets that vary in completeness from raw, unprocessed data to verified summaries and interpretations that appear as abstracts or letters. A common form of rich information that is completely impossible to search for the tables and graphs from scientific publications along with materials and methods sections. Our proposed framework will bring many disparate data sources together, with the variable certainty and confidence, into a structure that allows any data to be expressed at multiple levels of detail, while still allowing all the data to be cross correlated and searched using types of queries that have never before been achievable.

Standard database technologies will not support these features because relationships between data are defined by rigid rules; they can only hold one version of the “Truth” and cannot resolve extremely complex relationships. They also cannot store multiple levels of detail to match changing needs of understanding of overtime.

Although there is continued use for relational databases wherein relationships between and among data are known, there is a need for a knowledge-base, which overcomes the previously presented problems and other associated problems, which further solves a long felt need.

### BRIEF DESCRIPTION OF THE INVENTION

One aspect of the present invention there is provided an irrelational knowledge-base comprising:

an irrelational knowledge-element for retaining knowledge, said knowledge-element retaining a knowledge;

a control element for enforcing a paradigm rule-set; and

a relationship modulator for modulating a relation among knowledge-elements and wherein the relationship modulator dynamically establishes said relationships according to said paradigm rule-set.

In an additional aspect of the present invention there is provided an examiner of an irrelational knowledge-base providing a multi-paradigmatical examination of the knowledge-base, said examiner comprising:

a. an interpreter of said knowledge-base for designation of knowledge-elements, said interpreter generating a knowledge-element;

b. a relationship-modulator for modulating formation of a relationship among knowledge-elements; and

c. a communication-modulator for modulating knowledge-element communication.

In some aspects, the examiner further comprises:

d. a dynamic display modulator in communication with a display device and a user command designator, said display modulator modulating communication with said display device, said display modulator communicating display changes to the display device; and said user command designator communicating a user command to said dynamic examiner where said designator receives user commands and communicates said commands to the dynamic examiner.

Moreover, an additional aspect of the present invention is directed to a method of forming a knowledge-base comprising:

i) providing an organizational paradigm for describing knowledge;

ii) providing irrelational knowledge-elements for acquiring knowledge and retaining said acquired knowledge,

iii) acquiring knowledge into the knowledge-elements; and

iv) allowing the knowledge-elements to establish inter-element relationships according to said organizational paradigm.

A further aspect of the present invention is directed to a computer system comprising an irrelational knowledge-base, as well as an examiner of said irrelational knowledge-base as described above.

An additional aspect of the present invention is directed to a method of forming a knowledge-base comprising:

i) providing an organizational paradigm for describing knowledge;

ii) providing irrelational knowledge-elements for retaining knowledge,

iii) acquiring knowledge into the knowledge-elements; and

iv) defining a build order rule-set through a user input whereby inter-element relationships are established.

A further aspect of the present invention is directed to a database management system comprising:

a knowledge-base store storing knowledge data;

an aggregation module, operatively coupled to the knowledge-base store, for aggregating the knowledge data and storing the resultant aggregated data in an irrelational multi-dimensional data store; and

a query servicing mechanism, operatively coupled to the aggregation module, for servicing query statements generated in response to user input.

### BRIEF DESCRIPTION OF THE DRAWINGS

FIG. 1 is a flow diagram of the logic used in generating the computer code to construct and display a query.

FIG. 2 is a flow diagram of the logic used in generating the computer code to open a stored collection and/or query and/or edit a stored query.

FIG. 3 is a flow diagram of the logic used in generating the computer code to create, delete and/or merge query sets.

FIG. 4 is a flow diagram of the logic used in generating the computer code to save and/or export queries and collections.

FIG. 5 is a flow diagram of the logic used in generating the computer code to run additional queries and/or append a query to another query.

FIG. 6 is a flow diagram of the logic used in generating the computer code to generate an interface and/or display user desired data.

FIG. 7 is a flow diagram of the logic used in generating the computer code to modulate relationship formation.

FIG. 8 is a flow diagram of the logic used in generating the computer code to load a stored query.

FIG. 9 is a flow diagram of the logic used in generating the computer code to determine related entity set.

FIG. 10 is a flow diagram of the logic used in generating the computer code to filter related entity set.

FIG. 11 is a graphical representation of a pseudo-hyperbolic viewer demonstrating nodes and relationships with additional cross-database relationships also shown. In this figure is depicted a node (144) also termed an irrelational knowledge-element Importantly, some nodes (144, 140 and 141) have formed relationships as depicted by either mono or bi-directional arrows, whereas some nodes (143) remains without relation, other than relation to the primary node (144) of the depicted query. Although not shown, the primary node of the next query, as determined by the user, would re-focus the database management system forming new relationships, and breaking many of the previous ones. Also depicted are relationships formed between unrelated tables (150, 149, 147 and 151). Indeed, relationship (151) can be formed between irrelational knowledge bases (152) and standard relational databases (153) even where no relation was known to exist.

FIG. 12 is a flow diagram of the logic used in generating the computer code to modulate irrelational knowledge-element generation.

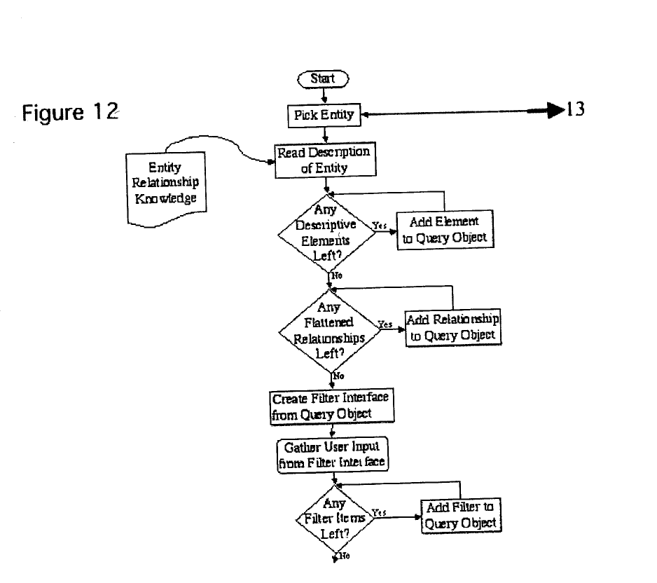

FIG. 13 is a flow diagram of the logic used in generating the computer code to modulate irrelational knowledge-element generation.

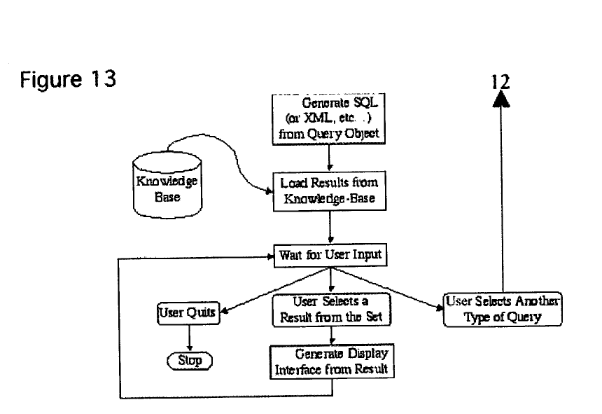

### DETAILED DESCRIPTION OF THE INVENTION AND PREFERRED EMBODIMENTS

One important aspect of the present invention concerns the organization of knowledge elements in a manner that makes them much more useful to persons interested in the field to which they relate, even if only tangentially. While the present invention is useful in commercial, governmental, academic and many other fields, it is particularly useful in scientific fields where researchers such as those working in governmental, academic or commercial organizations or in several different organizations require collaboration such as in joint projects. The present invention makes it possible for knowledge-elements derived from diverse sources and, indeed, in different languages and related to different protocols points of view, and the like., to be correlated and rendered accessible in a highly efficient fashion.

As used in this specification and the appended claims, the singular forms “a”, “an”, and “the” include plural references unless the context clearly dictates otherwise. Thus, for example, references to analysis of “a library” includes analysis to pooled sequence data of more than one library unless otherwise specified. References to “a method” may likewise include one or more methods as described herein and/or which will become apparent to those persons skilled in the art upon reading this disclosure.

Unless defined otherwise, all technical and scientific terms used herein have the same meaning as commonly understood by one of ordinary skill in the art to which the invention belongs.

Although any methods and materials similar or equivalent to those described herein can be used in the practice or testing of the present invention, the preferred methods and materials are now described. All publications mentioned herein are incorporated by reference for the purpose of disclosing and describing the particular information for which the publication was cited.

The publications discussed are provided solely for their disclosure prior to the filing date of the present application. Nothing herein is to be construed as an admission that the invention is not entitled to antedate such disclosure by virtue of prior invention. The knowledge-base according to the present invention does not require hierarchical information to be organized. This is advantageous because members of a group of persons interested in the field in question, e.g., scientific researchers, often have many different viewpoints or perspectives and a hierarchy can represent only one such perspective. In one embodiment of the present invention the knowledge-base consists of nodes and arcs which may be generally understood to represent knowledge-elements. A node represents one concept and an arc from one node to another may include a label that indicates a link or relationship between the two nodes. A set of nodes, labels and arcs represents a set of information termed a knowledge-base. It is possible to share sets of information represented in two or more knowledge-bases by merging them into one knowledge-base. Although two sets can be merged by adding extra labels and arcs, there is a significant trade-off between flexibility and maintainability of merged sets as compared to a knowledge-base containing the merged data, but which is not the result of that type of merge.

Data is stored in knowledge-elements within the present knowledge-base. Knowledge-elements in the present knowledge-base are irrelational in that they have no implicit relationship, yet contain descriptors that facilitate explicit relationship formation. Explicit relationships among and between irrelational knowledge-elements further facilitates formation of both positive and negative relationships. The relationships thus formed among irrelational knowledge-elements can also be grouped into hypotheses and hypotheses can overlap to contain other hypotheses within the knowledge-base. The database management system of the present invention thereby facilitates the merging of one or more relational databases through irrelational knowledge elements forming a multi-paradigmatical knowledge-base. The data defines the level of the relationship instead of forcing the data into a pre-defined relationship.

The present knowledge Base is an entity relationship model represented as a directed hypergraph, or pseudo-hyperbolic system The nodes the graphs represent the various types of entities ranging from detailed data on the gene to detailed experimental data, including such entities as steps in a protocol and resources used in the steps. The edges in the graph represent various cells as related to a hierarchical dynamic system. Avoidance of this difficulty is but one of many advantages provided by the present invention. In addition, the present invention is vastly more robust than are prior information structures, and the present invention provides means for attaining the greatly-desired benefits of generality, commonality and robustness to the knowledge-bases provided hereby. Thus, persons from very diverse backgrounds, using different languages, having views concerning different theories and points of view, and otherwise, can all contribute to common knowledge structures in a way that makes all such contributions available to the contributors and, indeed, to others who may have access to the knowledge structure. Moreover, the structures of the present invention are robust in that they may be expanded, merged, and divided without significant difficulty and they are available in easily accessible forms. Thus, through employment of the knowledge structures, methods and protocols of the present invention, persons have access to extraordinary numbers of knowledge elements and also have access to the means for interrelating such elements to achieve knowledge syntheses or a correlation of such elements, often in ways which would not be suspected absent the present invention.

The knowledge structures of the present invention are viewed as being multi-paradigmatical. In this regard, these knowledge-bases are seen to be able to provide correlation among diverse knowledge elements, which correlation and knowledge synthesis would not be apparent absent the present invention. This insight makes it possible to observe relationships and develop conclusions, theories and understandings which would be either impossible or unlikely absent the use of the present invention. Moreover, the knowledge-bases of the invention may, themselves, generate further knowledge elements for addition to their inherent knowledge structures such that the same may be seen to “grow” without direct intervention of human operators.

Accordingly, the present invention provides a knowledge-base interpreter and display methods and protocols which are, at once, novel and which are capable of great utility commercially, academically, governmentally, scientifically, and otherwise.

As used in connection with the present invention, the term “knowledge-element” includes, data; observations; correlations; hypotheses; experimental protocols, theories, implementations, data, data tables, and other experimental information; theories; intuitive suggestions; taxonomies milieus; lists; facts; and other things which, directly or indirectly, may give rise to either other knowledge elements or to one or more knowledge syntheses.

A “knowledge syntheses” as used in herein, is a result of the confluence of a number of knowledge elements by virtue of their organization into a knowledge-base in accordance with the present invention and the access of that knowledge-base in accordance with the methods and protocols hereof to achieve an understanding of the significance, meaning, relationship, or interplay among a plurality of such knowledge-elements of the knowledge-base. Knowledge syntheses are, themselves, knowledge-elements, and may be added to the knowledge-base from which further knowledge syntheses may be derived.

The present invention provides an examiner of a database management system which itself may contain more than one database including relational databases and irrelational knowledge-bases providing a dynamic and multi-paradigmatical examination of the entirety of the combined knowledge. The present database management system facilitates dynamic generation of relationships between and among irrelational and relational elements of the databases organized thereunder. The examiner presents the data of those managed databases through a first display paradigm which, through user selection may incorporate elements from several databases under numerous organizational paradigms. The option of incorporating databases regardless of organizational structure facilitates unrestricted analysis of the data. Where a relational database allows analysis of its data, that analysis must occur under the relationship rules of the database. The use of irrelational elements under a multi-paradigmatic system diminishes those restrictions. Determination of new and unanticipated relationships and inter-involvement's between and among knowledge-elements is one important result of practicing this embodiment.

In one preferred embodiment of the present invention there is provided an inspector of the database management system, which may contain databases of different organizational paradigms, for inspecting and dynamically forming relationships between and among irrelational knowledge-elements. The user of the database management system may re-define the analysis perspective to suit their need. The inspector will, accordingly, re-define its internal analysis paradigm to match that requested. The relationships among knowledge-elements is also re-defined or re-focused to match the user's desire. Indeed, because the viewer enables the examination of the knowledge-base under numerous paradigms and from numerous perspectives, the user is presented with relationships between knowledge-elements that are useful and perhaps unforeseen. The examiner is further enabled with a relationship modulator, which facilitates the formation or removal (modulation) of relationships between knowledge-elements. The relationship modulator is as well dynamic, reforming relationships secondary to a determination by the inspector of a relationship existing between irrelational knowledge-elements. More particularly, the inspector is able to ask of each irrelational knowledge-element information about itself and of other irrelational knowledge-elements that have a relationship with it. The database management system is thereby not restricted to analysis of hierarchical knowledge but is able to inspect and examine knowledge regardless of organizational parameters and limitations.

It will be appreciated that for many implementations of this invention, it is desired to apply the present considerations to a particular field of endeavor, science, technology, mathematics, economics, business, data manipulation, demographics, and others of a host of potential uses. In such cases, it is desirable that the knowledge-elements be selected from a pre-selected set of knowledge-element types related to the particular field of endeavor. Likewise, the relationships are selected form a pre-selected set of relationship types, also directed to the particular field of endeavor. Although the relationships may be arranged hierarchically to define a hierarchy of knowledge, they may also be arranged some other way, perhaps semantically, whereby relationships are not pre-defined but become defined only during analysis.

Important in the present invention is the ability for irrelational knowledge-elements to understand and manipulate themselves and their neighbors. Moreover, all relationships formed between and among irrelational knowledge-elements exist themselves as knowledge-elements and may therefore further act on themselves and their neighbors; thereby availing the formation of unforeseen relationships.

Certain aspects of the invention provide that the database management system is in control of knowledge-bases distributed over a wide area such that scientific collaboration is facilitated. Distribution over a plurality of computer readable storage media accessible to computers on a network is preferred in some respects. The network may be either a local area network, intranet, wide area network, the Internet, or, indeed, may comprise network structures in forms which are not presently known, so long as the basic tenants of the present invention are adhered to. In this way, the data structures may be added to via such networks and the computers attendant thereto. Through use of the present invention, it becomes possible to assess confidence levels' of suspected relationships and hypotheses and to perform useful research using data stored in numerous computer systems in diverse areas.

An additional embodiment of the present invention also provides for the control of systems and devices, via database management systems and associated knowledge bases taught herein. Such knowledge bases may not only give rise to knowledge synthesis or higher forms of knowledge or understanding, but they may also control manipulable devices and systems to cause physical transformations, actions, reactions, responses, tests, movements, and a host of other consequences to occur. Such may, in course, give rise to further knowledge elements and these may be added to the original knowledge structures, such that self-fulfilling operations take place.

A further, yet preferred use for the present database management system is the control of robotic systems and other manipulable devices and systems. This is especially useful where the databases to be managed include instruction sets for robotics manipulation, i.e. those which control and schedule scientific experimentation. The ability to organize, schedule, and control overall a robot or series of robots which manipulates test instruments and samples, especially those dealing with biochemical research, is very valuable and has long been sought. Of particular importance is the fact that such control may employ forms of feedback such that knowledge elements derived from the test themselves may provide further input into the control structures by becoming part of the knowledge bases used in that control.

Perforce, such operative control of robotic and other manipulable systems takes place through at least one interface, either a control cable, bus, or other form of data exchange. Clearly, a plurality of devices may also be controlled and made to interface and cooperate with each other. This can readily be seen in the scientific field where samples are obtained, selected, stored, moved, decanted, reacted with, irradiated, exposed, illuminated, considered, tested and otherwise manipulated to give rise, for example, to test results. Of particular interest is the fact that test information together with information concerning the actual testing, the control of the testing, conditions of the testing and the like can be generated for further input as knowledge elements into the knowledge structure from which control derives. This may be seen to be a form of feedback such that ongoing test information and hypotheses can influence the completion of the testing. Such feedback facilitates extremely robust and sophisticated developmental and testing protocols.

The control of robotic systems in scientific endeavors is but one exemplary use of the present invention. Indeed, the invention is widely and generally useful in both commercial and non-commercial fields. All forms of scientific, economic, sociological, and other forms of research, development and related endeavor may employ the present invention. It may also be applied to commercial areas as well. For example, marketing, sales, order fulfillment, transportation, and other commercial fields may benefit from the invention. Manufacturing activities of all sorts from refining to fabrication, to inventory to distribution may also be benefited hereby. As will be seen, the present invention is illustrated chiefly with regard to one field of endeavor biotechnology but it is to be understood that this is merely for convenience. The breadth of the present invention is not to be considered limited in any way by reliance upon a single field for purposes of illustration.

The knowledge-base of the present invention, which interrelate knowledge-elements through relationships permit the robust and facile accessing of diverse knowledge-elements, including those whose relationships are not immediately apparent. The knowledge-elements within the knowledge-base in accordance with this invention represent various types of entities ranging from detailed genomic data to detailed experimental meta-data including such entities as steps in a protocol and resources used in those steps. Through establishment of knowledge-elements and associated relationships in accordance with this invention, (and by reference to the exemplary field of scientific research) it is possible to provide for and facilitate the analysis of competing hypotheses and ambiguity in scientific and other data; straightforward representations of positive as well as negative results; multiple uses for names of such things as proteins, genes, and chemical compounds without loss of precision; integration of physical concepts such as experimental protocols and biochemical reactions with their intellectual interpretations such as hypotheses about cell or gene function; and support for a high degree of physical distribution of the data to enable local ownership and management, and peer reviewed public repositories, while allowing global search and query processing.

The knowledge-base of the present invention must, perforce, be first defined and populated with initial sets of data. A system for accomplishing this conveniently is effectuated through a procedure for acquiring, assessing, and storing data including anticipatory knowledge-elements of relevance to the knowledge-base to be created, together with relationships known or suspected among the knowledge-elements. Importantly, the relationships will be determined to a large extent during analysis of the knowledge-base. During the construction phase, significant thought must be applied to classification of data with foresight to commonalties across disciplines. This applied classification within the knowledge-base facilitates the dynamic formation of relationships between knowledge-elements.

Once a meaningful number of knowledge-elements are captured and relationships formed, a useful knowledge-base arises. In order to make good use of the structure, methods and tools are needed to assess the relationships among the knowledge-elements. The knowledge syntheses thus gained may be used in a number of ways. Such insight may be used to generate or acquire additional knowledge-elements for the development of richer insights. Additionally, such may be seen to form a desired, ultimate element of knowledge, useful per se. Further, manipulable devices may be controlled therewith either to generate desired output directly or to acquire additional knowledge-elements. All of these objectives may, of course, be applied to the full range of beneficial uses comprehended herein.

Thus, the present invention can be utilized in a computer network environment having client computing devices for accessing and interacting with the network and a server computer for interacting with client computers. However, the systems and methods of the present invention can be implemented with a variety of network-based architectures, and thus should not be limited to the example shown. The present invention will now be described in more detail with reference to a presently illustrative implementation.

The present invention provides system and methods for finding, organizing and manipulating scientific information. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments. The various techniques described herein may be implemented in hardware or software, or a combination of both. Preferably, the techniques are implemented in a computer environment including a processor, a storage medium readable by the processor (including volatile and non-volatile memory and/or disk storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., optical, binary-electronic or magnetic) that is readable by a general or special purpose computer for configuring and operating the computer when the storage medium or device is read by the computer to perform the procedures described above. The system may also be considered to be implemented as a computer-readable storage medium, configured with a computer program or knowledge structure, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

### EXAMPLES

### Example Object Types

The following list of objects is illustrative of relationship modulators useful in the practice of the present invention using both irrelational knowledge-bases and public relational databases.

GeneTrove POV Plug-Ins

Gene

Sequence

Experiment

Starting Material

Treatment

Endpoint

Gene Groups POV Plug-Ins

Gene

Sequence

Experiment

Starting Material

Treatment

Endpoint

Gene Group

BIRD POV Plug-Ins

Molecular target

BIRD gene

Gene synonym

Target subsequence

Alternate name

Base accession

BIRD accession to Unigene ID

Target Subsequence Feature

Sequence Secondary Feature

Session

Site

Site Secondary Target

Site Oligo

Oligo

Lead Oligos

Primer Probe Set

Order Info

Experiment title

Experiment Isis number

Experiment keyword

Experiment molecular target

Affymetrix probe sets

Affy probe sets to BIRD molecular targets

Affymetrix accession to Unigene ID

Molecular target to LocusLink ID

Molecular target to Unigene ID

LocusLink ID to Accession index

LocusLink ID to Unigene ID index

LocusLink ID to GeneOntology ID index

Cell lines

Sequence feature Type

Gene class

Gene family

Gene subclass

GC target link

Primer probe validation data

Relationship type

Sequence source

Sequence molecule type

Sequence source type

Species

Subsequence status

Target deferral history

Target deferral reason

RTS notes

Chemistry position

End cap

Heterocycle

Linker

Base composition

Oxidation

Resin

Scramble control

Sugar

Unit

Unit link

Unit list

Oligo amounts

Lot record

Large scale distribution

Large scale oligo inventory

Mass spec

Percent purity

Purification method

Scale unit

Synthesis

Patent info

Target Participants

Site and session

Scientists

Department

Notebook

Research program

Plug-Ins for Public Relational Database

Paper (self-related to store references)

Journal

Author

### Example 2

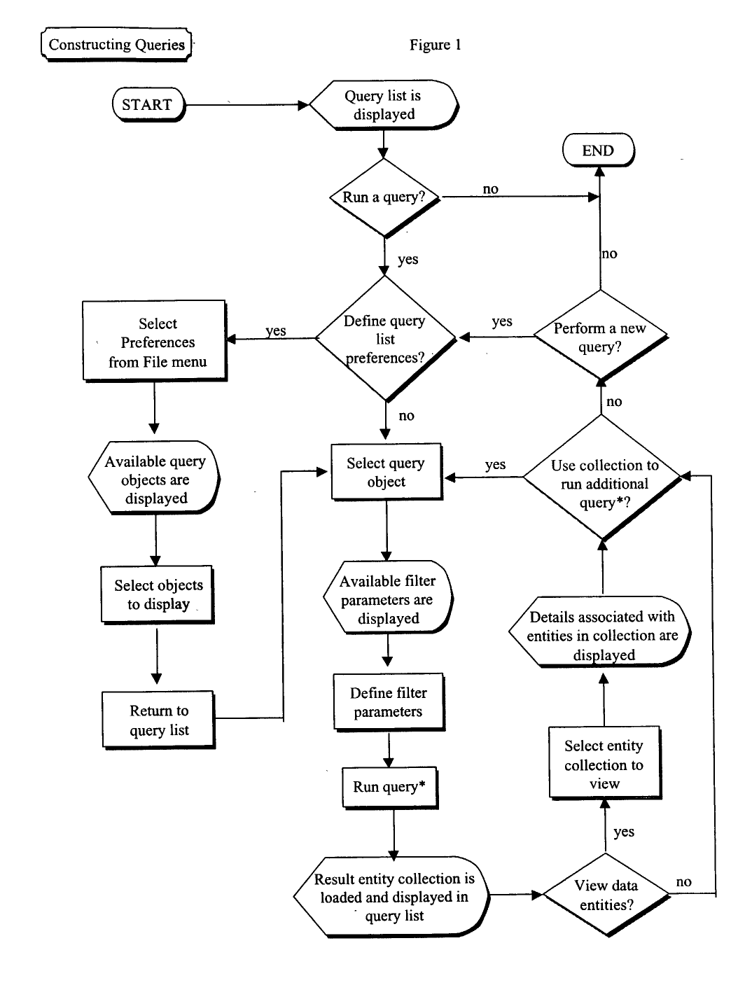

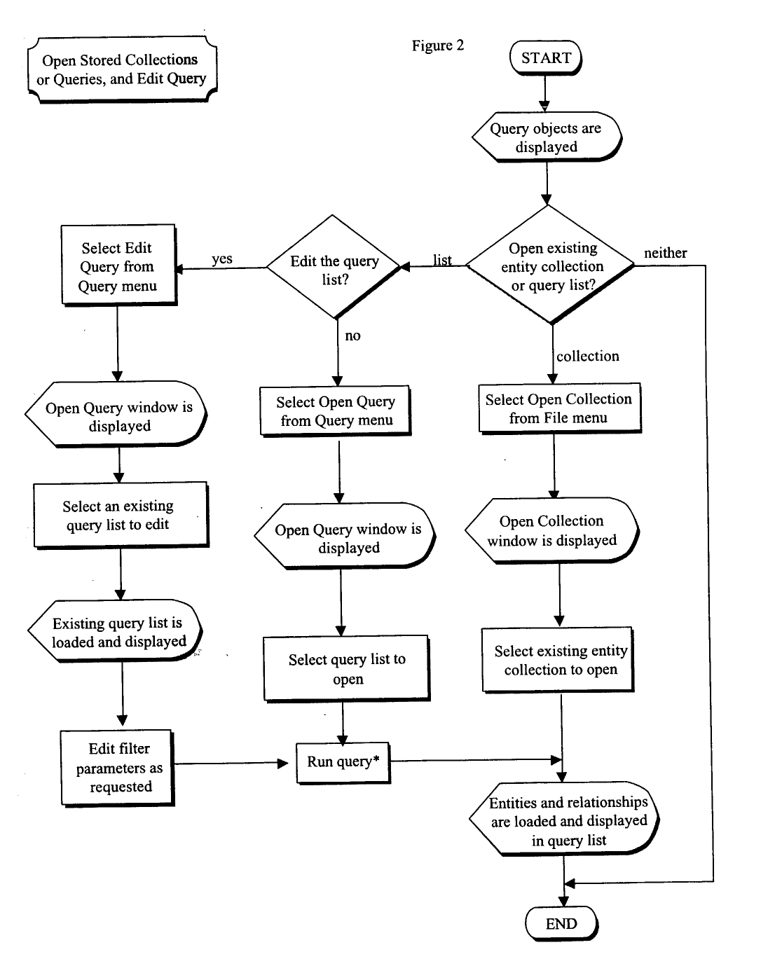

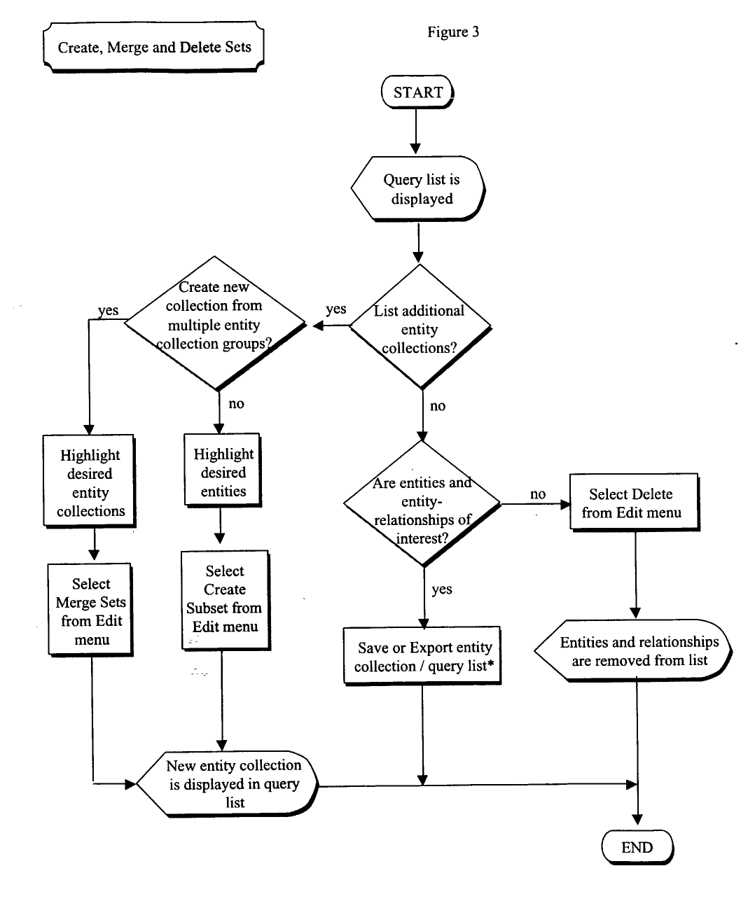

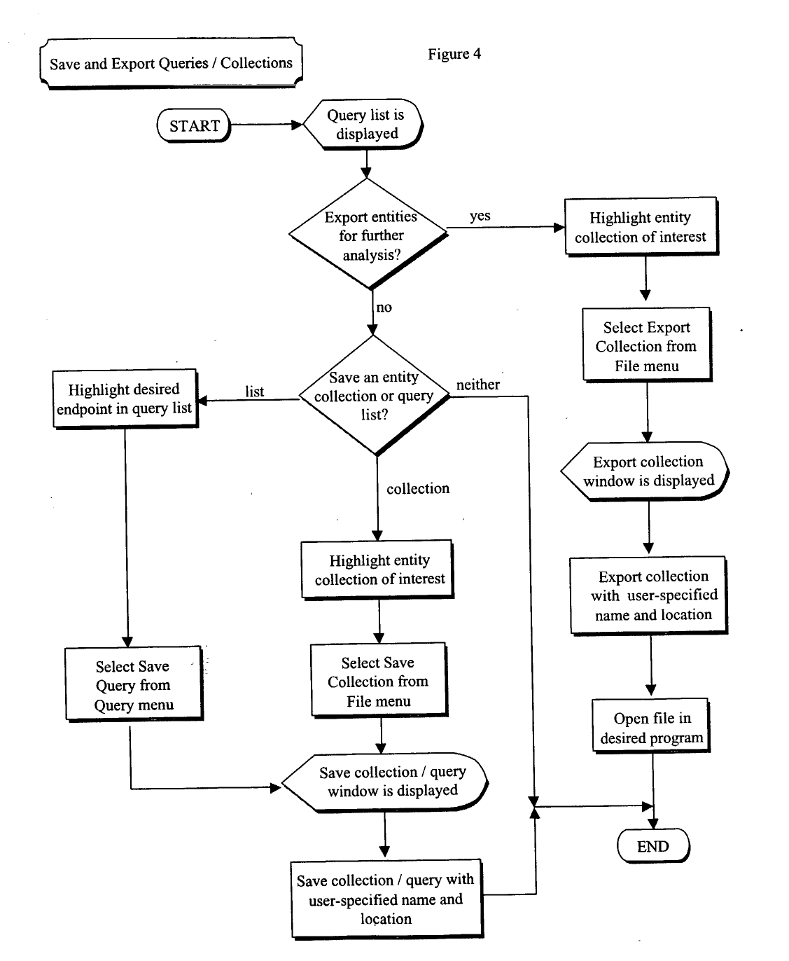

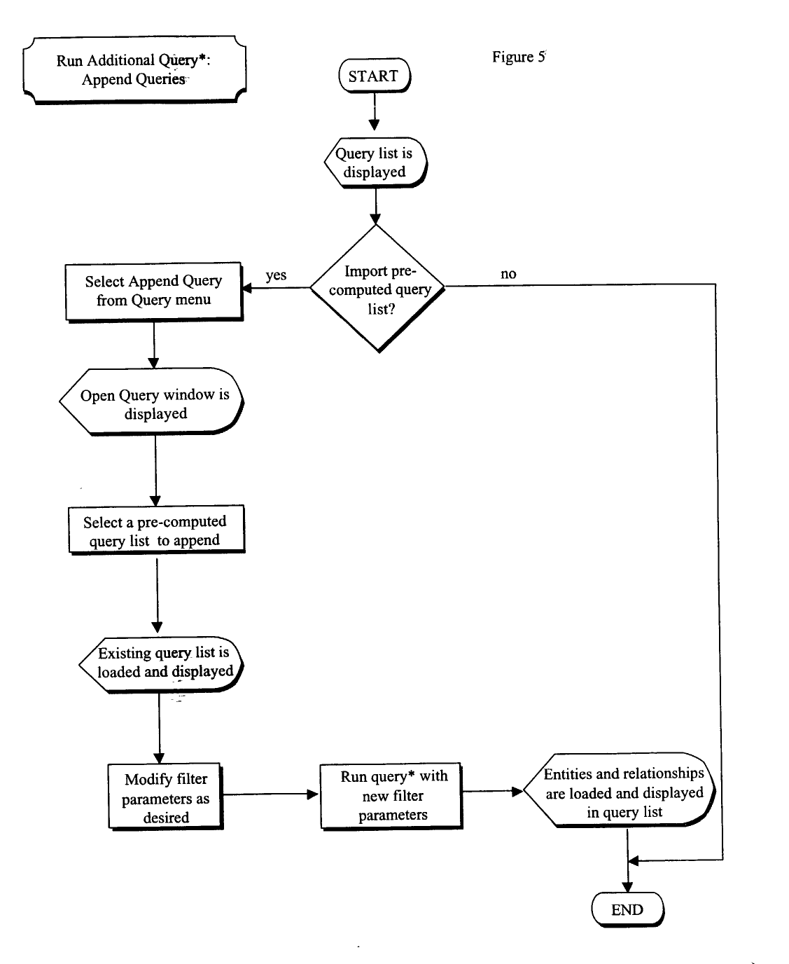

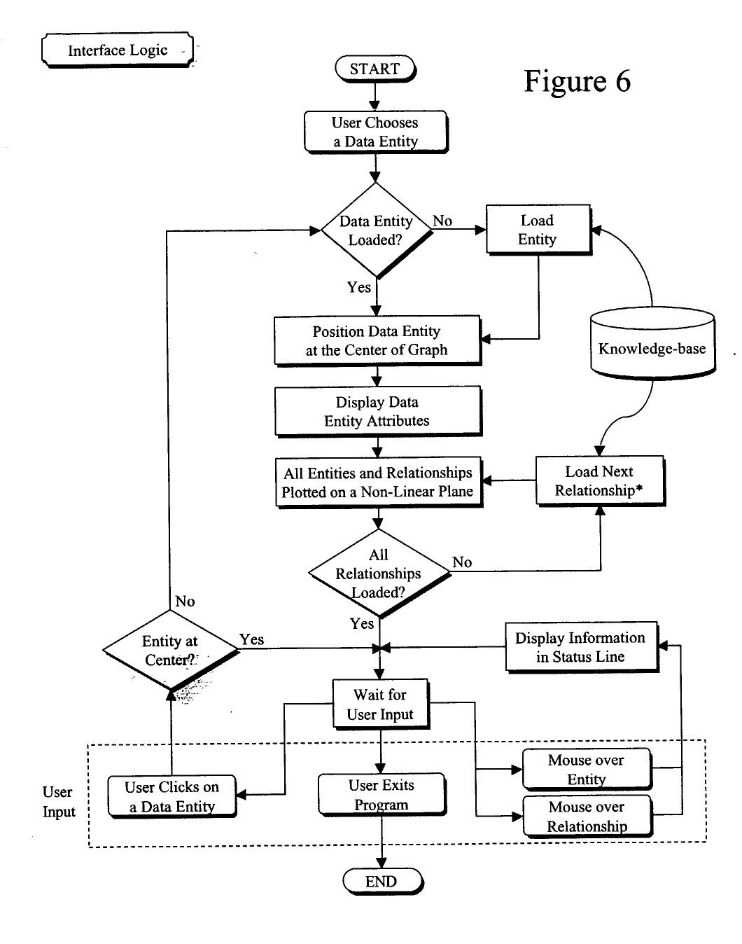

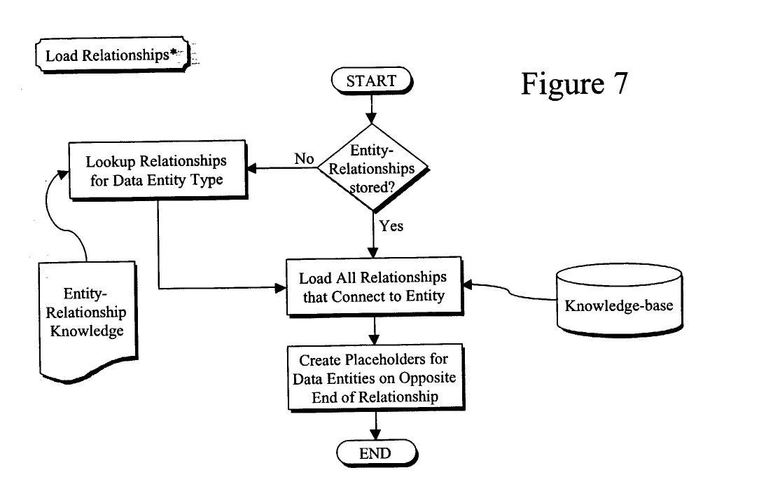

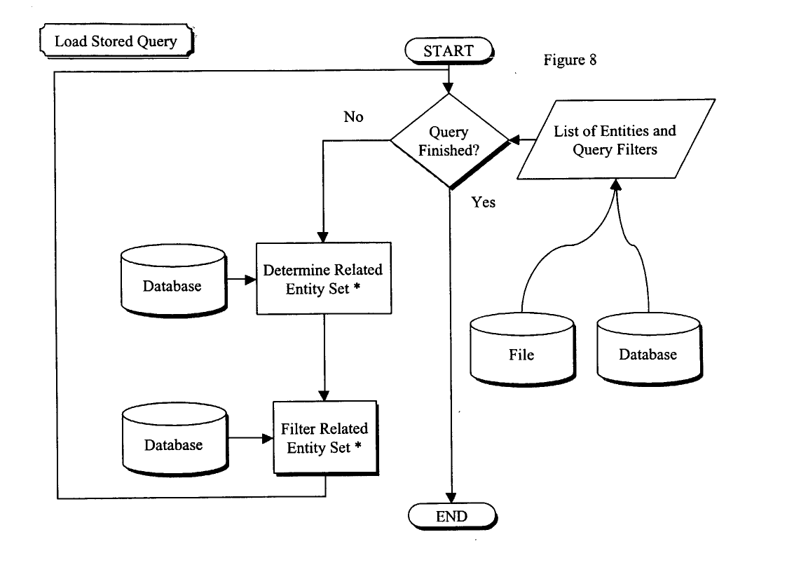

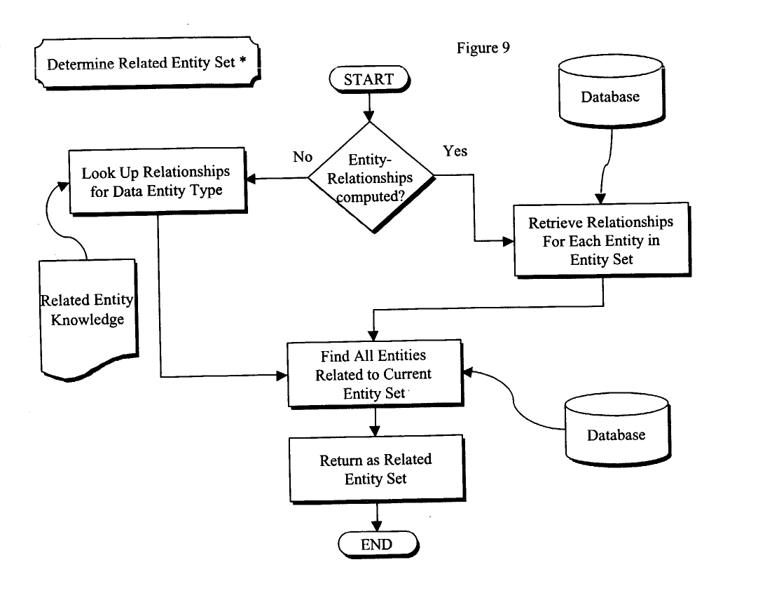

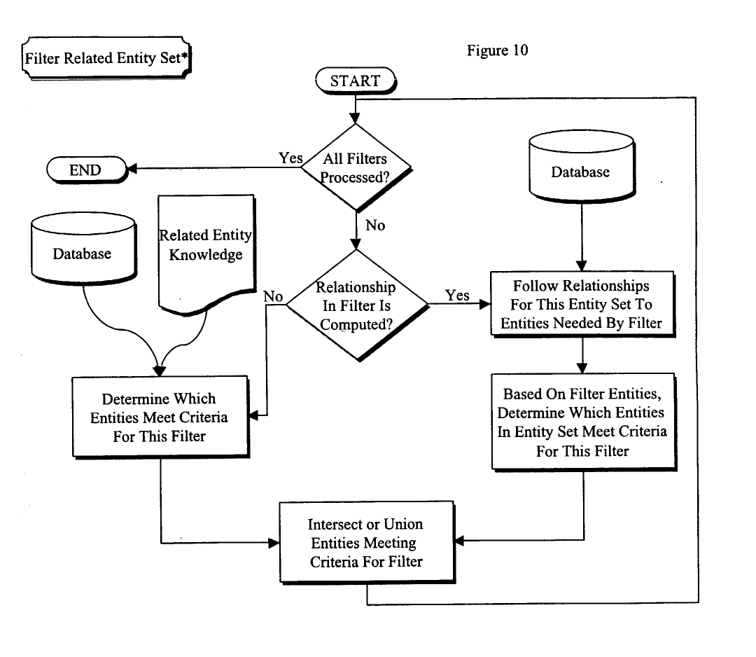

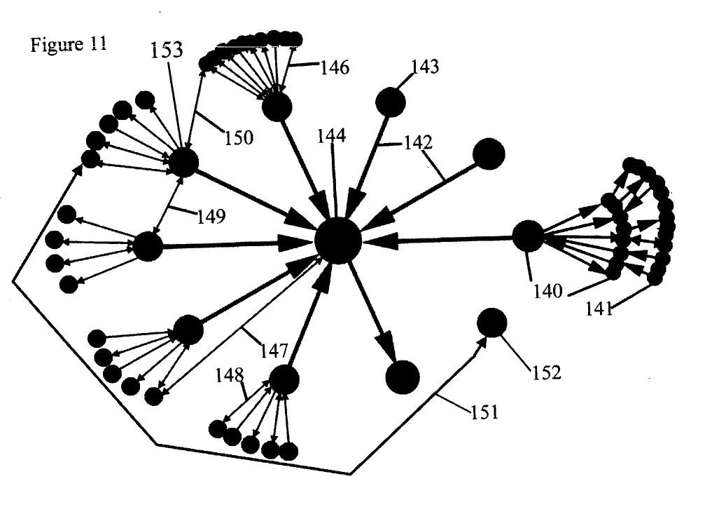

In this example a hypothetical query is performed on a database management system containing both an irrelational database and a relational database called PubMed, which can be found on the World Wide Web at www.pubmed.com. The logic involved in the query is depicted in FIG. 1-11b and the interface was designed according to methods known in the art.

Query Using PubMed POV

I would like to know if my favorite gene, MFG, is involved in arthritis. First, I would perform a search for Abstracts that contain the word “MFG”, and using the results from this search (List 1), I would perform another query for all associated Papers (List 2). Next, I would search for any Papers that contained the word “arthritis” in the title (List 3). The software would now be showing one list of abstracts, and two lists of papers. To find out if MFG is involved in arthritis, I would merge List 2 and List 3, and choose to intersect the two lists. I would then scan the resulting merged list of papers (List 4) to try to find my answer. I may find a paper (Paper 1) which contains data relating MFG to inflammation, but which does not definitively link MFG to arthritis. To focus on Paper 1, I would create a subset of it from List 4, and do another search to find all of the papers that reference or are referenced by Paper 1 (List 5). I would find all of the Abstracts associated with the papers in List 5 (List 6), and determine whether the definitive data have been published. I may find Abstract 1, which details the role of MFG in arthritis. I would create a subset of Abstract 1, and find the associated paper (Paper 2). I would then click on hyperlinks to the figures to examine the data, and on the hyperlink to “Paper 2.pdf” to print a copy.

We claim:

1. An irrelational knowledge-base comprising:
an irrelational knowledge-element for retaining knowledge, said knowledge-element retaining a knowledge;
a control element for enforcing a paradigm rule-set; and
a relationship modulator for modulating a relation among knowledge-elements.

2. The knowledge-base according to claim 1 wherein the relationship modulator dynamically establishes said relationships according to said paradigm rule-set.

3. The knowledge-base according to claim 1 wherein the paradigm rule-set is pseudo-hyperbolic.

4. The knowledge-base according to claim 1 wherein the control element enforces integrity of the paradigm within the knowledge-base and among the knowledge elements.

5. The irrelational knowledge-base according to claim 1 wherein said irrelational knowledge-elements are comprised of at least one relational knowledge-element.

6. The irrelational knowledge-base according to claim 5 wherein said at least one relational knowledge-element is a relational database.

7. The irrelational knowledge-base according to claim 6 wherein said relational database contains records pertaining to a plurality of bimolecular sequences and wherein said paradigm rule-set within said relational database is hierarchical.

8. The irrelational knowledge-base according to claim 1 wherein the relationship is established in the code pre-compile.

9. The irrelational knowledge-base according to claim 1 wherein at least one knowledge element is further comprised of biomolecular data.

10. The irrelational knowledge-base according to claim 9 wherein said biomolecular data comprises a data selected from the group consisting essentially of; Gene, Sequence, Experiment, Starting Material, Treatment, Endpoint and Gene Group.

11. An examiner of an irrelational knowledge-base providing a multi-paradigmatical examination of the knowledge-base, said examiner comprising:
a. an interpreter of said knowledge-base for designation of knowledge-elements, said interpreter generating a knowledge-element;
b. a relationship-modulator for modulating formation of a relationship among knowledge-elements; and
c. a communication-modulator for modulating knowledge-element communication.

12. The examiner according to claim 10 further comprising:
d. a dynamic display modulator in communication with a display device and a user command designator, said display modulator modulating communication with said display device, said display modulator communicating display changes to the display device; and said user command designator communicating a user command to said dynamic examiner where said designator receives user commands and communicates said commands to the dynamic examiner.

13. A method of forming a knowledge-base comprising:
i) providing an organizational paradigm for describing knowledge;
ii) providing irrelational knowledge-elements for acquiring knowledge and retaining said acquired knowledge,
iii) acquiring knowledge into the knowledge-elements; and
iv) allowing the knowledge-elements to establish inter-element relationships according to said organizational paradigm.

14. A computer system comprising an irrelational knowledge-base according to claim 1.

15. The computer system according to claim 14 further comprising an examiner of the irrelational knowledge-base according to claim 10.

16. A method of forming a knowledge-base comprising:
i) providing an organizational paradigm for describing knowledge;
ii) providing irrelational knowledge-elements for retaining knowledge,
iii) acquiring knowledge into the knowledge-elements; and
iv) defining a build order rule-set through a user input whereby inter-element relationships are established.

17. A database management system comprising:
a knowledge-base store storing knowledge data;
an aggregation module, operatively coupled to the knowledge-base store, for aggregating the knowledge data and storing the resultant aggregated data in an irrelational multi-dimensional data store; and
a query servicing mechanism, operatively coupled to the aggregation module, for servicing query statements generated in response to user input.

18. The database management system according to claim 17 wherein said query servicing mechanism further comprises:
a reference generating mechanism for generating a user-defined reference to aggregated fact data generated by the aggregation module; and
a query processing mechanism for processing a given query statement, wherein, upon identifying that the given query statement is on said user-defined reference,
communicates with said aggregation module over an interface therebetween to retrieve portions of aggregated fact data pointed to by said reference that are relevant to said given query statement.

19. The database management system of claim 17, wherein said aggregation module includes a query handling mechanism for receiving query statements, and wherein communication between said query processing mechanism and said query handling mechanism is accomplished by forwarding the given query statement to the query handling mechanism of the aggregation module.

20. The database management system of claim 19, wherein said query handling mechanism extracts knowledge-element data from the received query statement and forwards the knowledge-element data to the storage handler; and wherein the storage handler accesses said knowledge-element data of the irrelational multi-dimensional data store based upon the forwarded knowledge-element data and returns the retrieved data back to the query servicing mechanism for communication to the user.

21. The database management system of claim 17, wherein said aggregation module includes a data loading mechanism for loading at least fact data from the knowledge-base store, an aggregation engine for aggregating the fact data and a storage handler for storing the fact data and resultant aggregated fact data in the irrelational multidimensional data store.

22. The database management system of claim 21, wherein said aggregation module includes control logic that, upon determining that the irrelational multi-dimensional data store does not contain data required to service the given query statement, controls the data loading mechanism and aggregation engine to aggregate at least fact data required to service the given query statement and controls the aggregation module to return the aggregated data back to the query servicing mechanism for communication to the user.

23. The database management system of claim 22, further comprising a data analysis engine.

24. The database management system of claim 23, for use as an enterprise wide data warehouse that interfaces to a plurality of information technology systems.

25. The database management system of claim 17, for use as a database store in an informational database system.

26. The database management system of claim 17, wherein said knowledge data is biological data.

27. The database management system of claim 17, wherein said query statements are generated by a query interface in response to communication of a natural language query communicated from a client machine.

28. The database management system of claim 27, wherein said client machine comprises a web-enabled browser to communicate said natural language query to the query interface.

29. The database management system of claim 17, wherein said interface that provides communication between said query processing mechanism and said aggregation module comprises a standard interface.

30. In a database management system comprising a knowledge-base data store storing knowledge-data at least of a member of the group consisting of; irrelational, relational or non-relational data, a method for aggregating the knowledge data and providing query access to the aggregated data comprising the steps of:
providing an integrated aggregation module, operatively coupled to the relational data store, for aggregating the knowledge-data and storing the resultant aggregated data in an irrelational data store;
in response to user input, generating a reference to aggregated fact data generated by the aggregation module; and
processing a given query statement generated in response to user input, wherein, upon identifying that the given query statement is on said reference, communicating with said integrated aggregation module over an interface operably coupled thereto to retrieve from the integrated aggregation module portions of aggregated knowledge-data pointed to by said reference that are relevant to said given query statement.

31. The method of claim 30, further comprising the step of extracting knowledge-element data from the received query statement and forwards the knowledge-element data to the storage handler; and
wherein the storage handler accesses said knowledge-element data of the irrelational multi-dimensional data store based upon the forwarded knowledge-element data and returns the retrieved data back to the query servicing mechanism for communication to the user.

32. The method of claim 30, wherein said aggregation module includes a data loading mechanism for loading at least fact data from the knowledge-base store, an aggregation engine for aggregating the fact data and a storage handler for storing the fact data and resultant aggregated fact data in the irrelational multi-dimensional data store.

33. The method of claim 32, wherein said aggregation module, upon determining that the irrelational multi-dimensional data store does not contain data required to service the given query statement, controls the data loading mechanism and aggregation engine to aggregate at least fact data required to service the given query statement and controls the aggregation module to return the aggregated data back to the user.

34. The method of claim 30, wherein said database management system is used as an enterprise wide data warehouse that interfaces to a plurality of information technology systems.

35. The method of claim 30, wherein said database management system is uses as a database store in an informational database system.

36. The method of claim 35, wherein said informational database system is a bioinformatics program.

37. The method of claim 30, wherein said query statements are generated by a query interface in response to communication of a natural language query communicated from a client machine.

38. The method of claim 37, wherein said client machine comprises a web-enabled browser to communicate said natural language query to the query interface.

39. The method of claim 38, wherein said interface that is operably coupled to said aggregation module comprises a standard interface.

40. The method of claim 39, wherein said standard interface is selected from the group consisting of OLDB, OLE-DB, ODBC, SQL, JDBC.
